(19) United States
(12) Patent Application Publication
(10) Pub. No.: US 2015/0264204 A1
(43) Pub. Date: Sep. 17, 2015

(54) DOCUMENT MANAGEMENT SYSTEM, DOCUMENT MANAGING METHOD, AND RECORDING MEDIUM STORING A DOCUMENT MANAGING PROGRAM

(71) Applicant: Takayuki INOUE, Kanagawa (JP)

(72) Inventor: Takayuki INOUE, Kanagawa (JP)

(21) Appl. No.: 14/643,087

(22) Filed: Mar. 10, 2015

(30) Foreign Application Priority Data
Mar. 14, 2014 (JP) 2014-051568
Feb. 27, 2015 (JP) 2015-038023

(51) Int. Cl. H04N 1/00; H04N 1/32

(52) U.S. Cl. CPC H04N 1/00214; H04N 1/00095; H04N 1/32379

(57) ABSTRACT

A document management system includes an image processing apparatus including a scanning unit and a transmission unit that transfers the scanned image data to an information processing apparatus as first image data and the information processing apparatus including a storing unit that stores image data in association with update information that indicates a version of the image data, an acquisition unit that acquires identification information for identifying the transferred first image data, a specification unit that obtains second image data corresponding to the identification information of the first image data from among the image data stored in the storing unit, a detection unit that compares the first image data with the second image data to detect difference, and a registration unit that updates update information of the second image data and registers the first image data in association with the updated update information if the detection unit detects the difference.

### CROSS-REFERENCE TO RELATED APPLICATION

This patent application is based on and claims priority pursuant to 35 U.S.C. §119(a) to Japanese Patent Applications No. 2014-051568, filed on Mar. 14, 2014 and No. 2015-038023, filed on Feb. 27, 2015 in the Japan Patent Office, the entire disclosure of which is hereby incorporated by reference herein.

### BACKGROUND

1. Technical Field

The present invention relates to a document management system, a document managing method, and a recording medium storing a document managing program.

2. Background Art

In case of managing document such as by registering or modifying document data, a technology that an apparatus scans a set of a cover sheet and document data for document management has been disclosed.

However, it has been impossible to acquire document data by a same operation as registering or updating the document data, such that it was not easy for a user to obtain a new document or a desired document.

### SUMMARY

An example embodiment of the present invention provides a novel document management system that includes an image processing apparatus including a scanning unit that scans a document into scanned image data and a transmission unit that transfers the scanned image data to an information processing apparatus as first image data and the information processing apparatus including a storing unit that stores image data in association with update information that indicates a version of the image data, an acquisition unit that acquires identification information for identifying the first image data transferred by the image processing apparatus, a specification unit that obtains second image data corresponding to the identification information of the first image data from among the image data stored in the storing unit, a detection unit that compares the first image data with the second image data to detect difference between the first image data and the second image data, and a registration unit that updates update information of the second image data and registers the first image data in association with the updated update information in the storing unit if the detection unit detects the difference.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a block diagram illustrating a configuration of an image processing apparatus as an embodiment of the present invention.

FIG. 2 is a block diagram illustrating a hardware configuration of a computer system as an embodiment of the present invention.

FIG. 3 is a schematic diagram illustrating a document management system as an embodiment of the present invention.

FIG. 4 is a block diagram illustrating a document management system as an embodiment of the present invention.

FIG. 5 is a diagram illustrating information stored in a database as an embodiment of the present invention.

FIG. 6 is a sequence diagram illustrating a process of acquiring and printing a registered document as an embodiment of the present invention.

FIG. 7 is a diagram illustrating a screen of searching a registered document as an embodiment of the present invention.

FIG. 8 is a diagram illustrating a screen of a search result as an embodiment of the present invention.

FIG. 9 is a sequence diagram illustrating a process of updating and printing a registered document as an embodiment of the present invention.

FIG. 10 is a diagram illustrating a screen of checking whether or not it is the latest version as an embodiment of the present invention.

FIG. 11 is a diagram illustrating a screen of updating the registered document as an embodiment of the present invention.

FIG. 12 is a diagram illustrating a screen of checking a new version as an embodiment of the present invention.

FIG. 13 is a sequence diagram illustrating a process if an extracted document version is not latest as an embodiment of the present invention.

FIG. 14 is a diagram illustrating a screen that notifies that the document cannot be updated as an embodiment of the present invention.

FIG. 15 is a sequence diagram illustrating a process if the extracted document remains unchanged as an embodiment of the present invention.

FIG. 16 is a diagram illustrating a screen that notifies that the document is not be registered as an embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In the following embodiment, the document data is easily obtained by the same operation as acquiring and updating the document data.

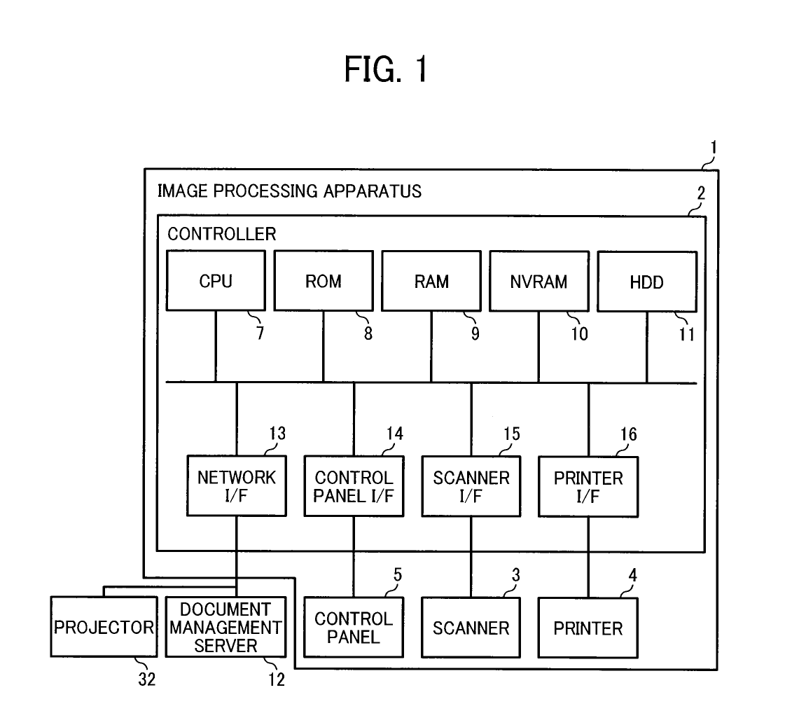

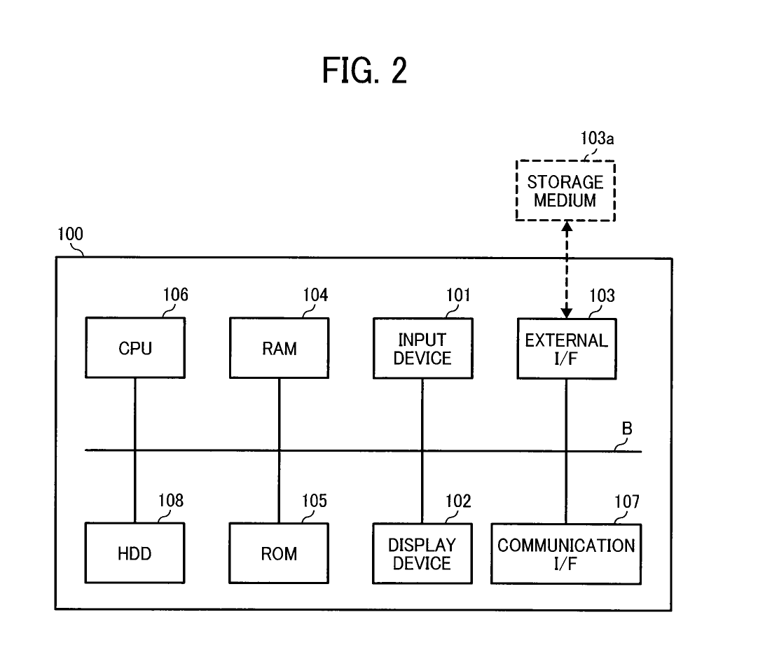

First, a hardware configuration of a document management system in this embodiment is described below with reference to FIGS. 1 and 2. FIG. 1 is a diagram illustrating a configuration of an image processing apparatus in this embodiment. FIG. 2 is a diagram illustrating a hardware configuration of a computer system in this embodiment. An image processing apparatus 1 includes a controller 2 that controls the whole image processing apparatus 1, a scanner 3 that scans a sheet, a printer 4 that prints an image on a sheet, and a control panel 5 that displays a status of the image processing apparatus 1 and accepts user operation.

The controller 2 includes a CPU 7 that executes commands in a software program, a ROM 8 that stores a program executed on the controller 2, a RAM 9 used as a page memory created by a controller software and a work memory used for running the software, and a NVRAM 10 as a nonvolatile memory that stores print settings of the image processing apparatus 1 etc. In addition, the controller 2 includes a HDD 11 that can store image data scanned by the scanner.

A projector 32 and a document management server 12 are connected to the image processing apparatus 1 via a network I/F 13. The controller 2 includes the network I/F 13 that exchanges data with the document management server 12, a control panel I/F 14 that controls the control panel 5, a scanner I/F 15 that receives image data scanned by the scanner 3, and a printer I/F 16 that exchanges an instruction on printing with the printer 4.

For example, the document management server is implemented by a computer system with a hardware configuration shown in FIG. 2.

A computer system 100 in FIG. 2 includes an input device 101, a display device 102, an external I/F 103, a RAM 104, a ROM 105, a CPU 106, a communication I/F 107, and a HDD 108 etc., and those components are connected with each other via a bus B. The input device 101 includes a keyboard and a mouse etc., and the input device 101 is used for inputting operation signals into the computer system 100.

The display unit 102 includes a display etc., and the display unit 102 displays a processing result by the computer system 100. The communication I/F 107 connects the computer system 100 to a network N1. As a result, the computer system 100 can perform data communication with an operation terminal and an electronic apparatus etc. via the communication I/F 107.

The HDD 108 is a nonvolatile storage device that stores programs and data. The stored programs and data include an Operating System (OS) that controls the whole computer system 100 and application programs that provide various functions on the OS etc. The HDD 108 manages the stored programs and data using a predetermined file system and/or a database.

The external I/F 103 is an interface with the external apparatus. A storage medium 103a is an example of the external apparatus. As a result, the computer system 100 can read/write data from/to the storage medium 103a via the external I/F 103. Examples of the storage medium 103a are a flexible disk, a Compact Disc (CD), a Digital Versatile Disk (DVD), a SD memory card, and a Universal Serial Bus (USB) memory etc.

The ROM 105 is a nonvolatile semiconductor memory (a storage device) that can keep programs and data after cutting power off. The ROM 105 stores a Basic Input/Output System (BIOS) executed during a boot-up sequence of the computer system 100, an OS configuration, and programs and data such as network settings etc. The RAM 104 is a volatile semiconductor memory (a storage device) that stores programs and data temporarily.

The CPU 106 controls the whole computer system 100 and implements functions of the computer system 100 by reading programs and data from the storage devices such as the ROM 105 and the HDD 108, expanding them into the RAM 104, and executing processes.

In the computer system 100 in this embodiment, various processes (described later) can be implemented by cooperating with the hardware resources and programs in combination with the hardware resources, programs, and data.

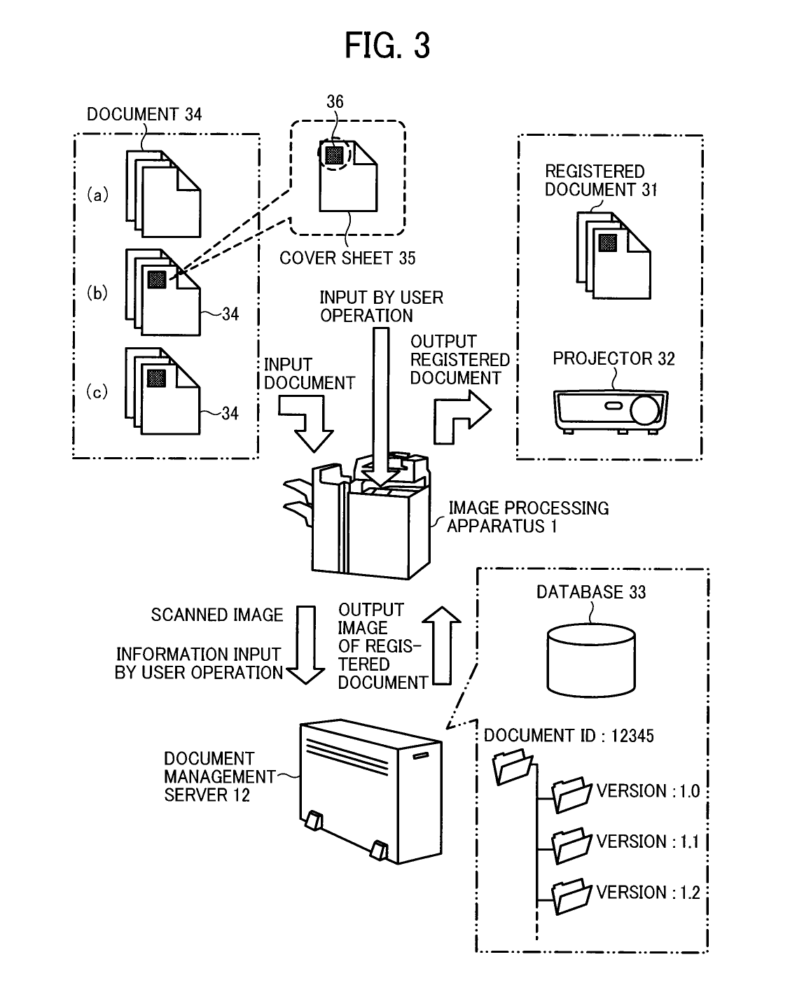

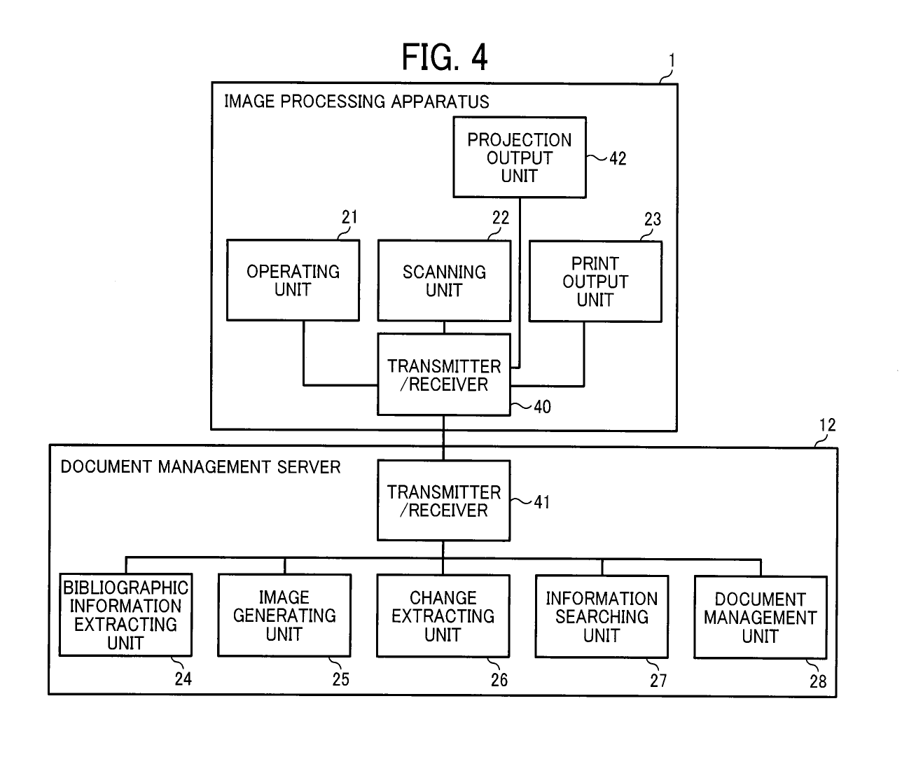

Next, schematic configuration of the document management system in this embodiment is described below with reference to FIGS. 3 and 4. FIG. 3 is a schematic diagram illustrating a document management system in this embodiment. FIG. 4 is a block diagram illustrating a document management system in this embodiment. The document management system includes an image processing apparatus 1 and a document management server 12.

The image processing apparatus 1 includes an operating unit 21, a scanning unit 22, a print unit 23, a transmitter/receiver 40, and a projection output unit 42. The scanning unit 22 is implemented by the scanner 3, and the scanning unit 22 scans a document and acquires image data of the document. The operating unit 21 is implemented by the control panel 5, and the operating unit 21 accepts user input.

The transmitter/receiver 40 transfers the scanned image and the user input information to the document management server 12 and receives a registered document 31 from the document management server 12. The print output unit 23 prints and outputs the registered document 31 stored in the document management server 12. The registered document can be output by the projector 32 instead of being printed by the print output unit 23. In this case, the projection output unit 42 transfers a projecting instruction and the registered document to the projector 32 via the transmitter/receiver 40.

The document management server 12 includes a bibliographic information extracting unit 24 that extracts (acquires) specific information (bibliographic information) for specifying the image data from the image data received from the image processing apparatus 1, an image generator 25 that generates the bibliographic information and an image of the registered document, a change extracting unit 26 that detects change in the image, i.e., difference in the image data, an information searching unit 27 that searches for the registered document, and a document management unit 28 that acquires and updates the registered document and registers a new document.

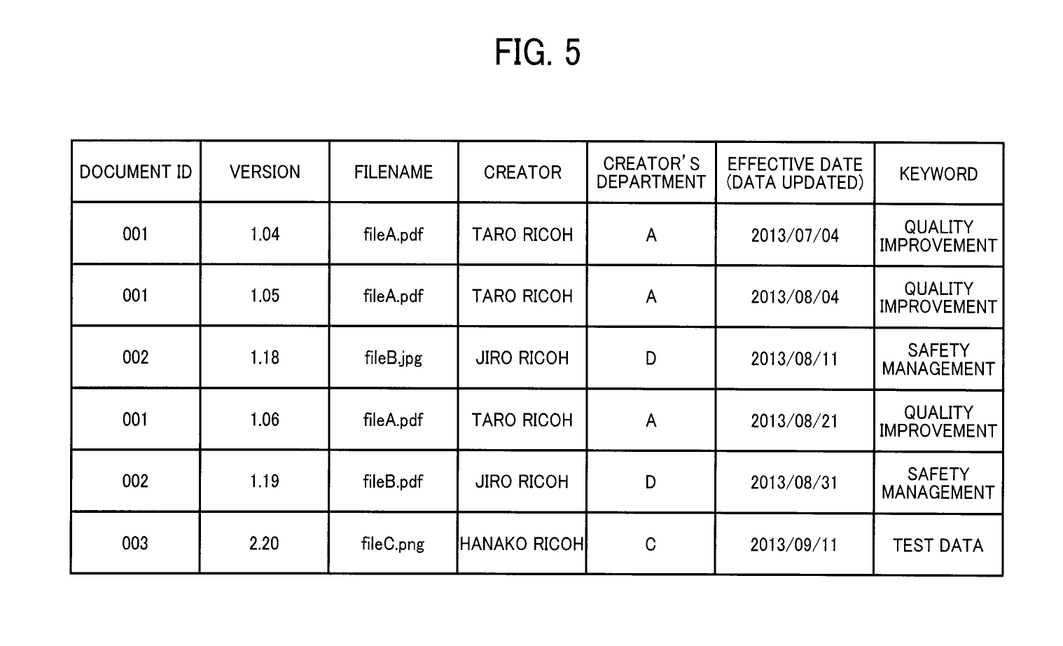

The document management server 12 includes a database 33 (not shown in figures), and the database 33 stores documents associated with information such as document IDs, document versions (update information) and attributes etc. Examples of the attribute are an author name, department, issue date, and keyword etc. FIG. 5 is a diagram illustrating information stored in the database 33 in this embodiment.

A cover sheet 35 of a document 34 includes an image indicating a bibliographic information 36 that includes the document ID and the version. There are three cases of the document 34, a case that only main pages are included without the cover sheet 35 ((a) in FIG. 3), a case that there is the cover sheet 35 or there is no cover sheet 35, e.g., the first page is the cover sheet and the remaining pages are not the cover sheets ((b) in FIG. 3), and a case that there are main pages with the cover sheet 35 ((c) in FIG. 3).

After extracting the bibliographic information 36 from the scanned image, the document management server 12 performs a process described below in accordance with the combination of the extracted information and the user input information.

If the document 34 includes pages without the cover sheet 35, the bibliographic information 36 and the document image are generated, the document 34 is registered in the database 33 as a new document, and the registered document 31 is acquired. The reason why the process described above is performed is that it is highly possible that the document without the cover sheet 35 has not been registered in the document management server 12 yet.

In the case that there is the cover sheet 35 or there is no cover sheet 35, the registered document is searched using the bibliographic information 36 as a key, images of the registered document is generated from the scanned images without the cover sheet and the bibliographic information 36, and the registered document 31 is acquired after updating the document in the database 33. The reason why the process described above is performed is that it is highly possible that the document with the cover sheet 35 has already been registered in the document management server 12 and the document is to be updated.

In the case that the document 34 consists of main pages with the cover sheet 35, the registered document 31 is searched and acquired using the bibliographic information 36 and a search condition of the user input information as a key. The reason why the process described above is performed is that it is highly possible that not the document is newly registered or the registered document is updated but the document that has already been stored in the document management server 12 is searched if the document consists of the cover sheet 35 only.

After performing the process described above, the document management server 12 transfers an image output of the registered document as the result of the process to the image processing apparatus 1. The image processing apparatus 1 prints out the received document using the print output unit 23. Otherwise, the image forming apparatus 1 projects the received document using the projector 32 via the projection output unit 42. It should be noted that the image processing apparatus 1 can include the bibliographic information extracting unit 24, the image generating unit 25, the information searching unit 26, and the document management unit 28 included in the document management server 12.

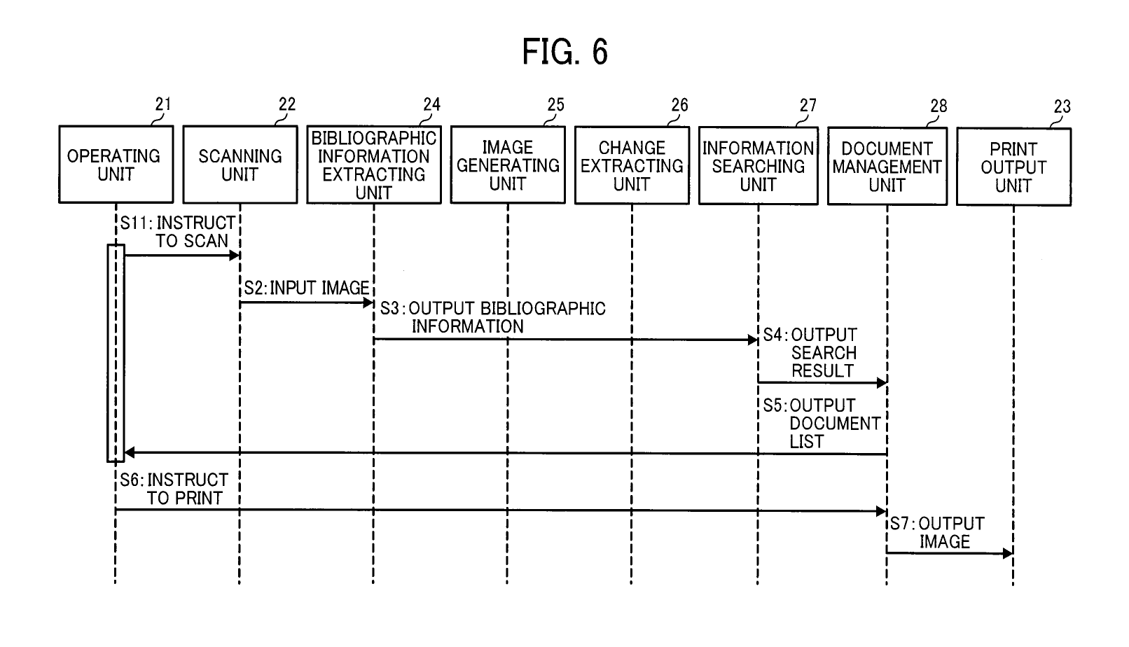

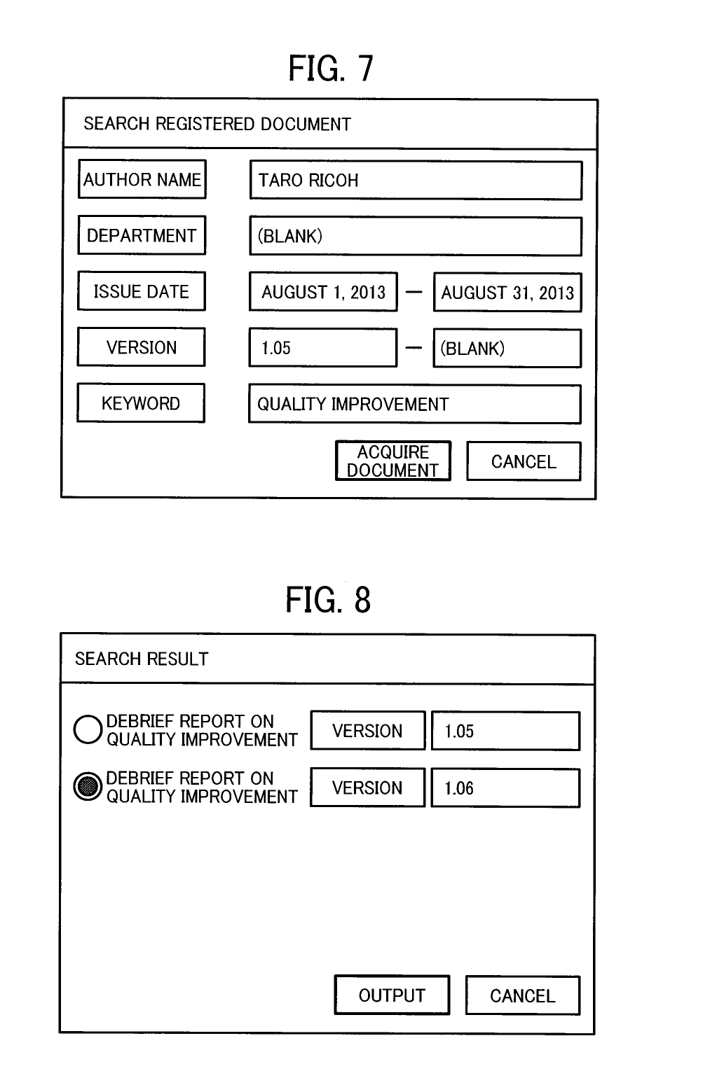

Next, a process that the image processing apparatus 1 acquires the registered document from the document management server is described below. FIG. 6 is a sequence diagram illustrating a process of acquiring and printing the registered document in this embodiment. FIG. 7 is a diagram illustrating a screen of searching a registered document as an embodiment of the present invention. First, the scanning unit 22 in the image forming apparatus 1 scans a document in S1. Here, before scanning the document using the scanning unit 22, it is possible that the image forming apparatus 1 displays a search condition input screen shown in FIG. 7 on the operating unit 21 and accepts inputting the search condition of the registered document by user operation.

As shown in FIG. 7, the search condition input screen displayed by the operating unit 21 accepts the search condition of the registered document (e.g., author name, department, issue date, version, free keyword etc.) and output method (by printing or projecting) by user operation. After pressing “Acquire Document” button, the operating unit 21 in the image processing apparatus 1 starts scanning the document using the scanning unit 22.

After scanning the document, the scanning unit 22 in the image forming apparatus 1 generates image data of the document and transfers the image data to the document management server 12 via the transmitter/receiver 40. It should be noted that the image data and the search condition is transferred to the document management server 12 if the image forming apparatus 1 accepts inputting the search condition. The bibliographic information extracting unit 24 in the document management server 12 specifies an image of the cover sheet from the image data received from the image forming apparatus 1 and acquires the bibliographic information (document ID information and document version information) from the image of the cover sheet in S2. For example, the bibliographic information can be expressed by an image such as a two-dimensional code.

The bibliographic information extracting unit 24 outputs the extracted bibliographic information to the information searching unit 27 in S3. The information searching unit 27 in the document management server 12 searches for the document corresponding to the document ID included in the bibliographic information extracted by the bibliographic information extracting unit 24 among documents stored in the database and outputs the search result to the document management unit 28 in S4. Here, in case of receiving the search condition from the image forming apparatus 1, the information searching unit 27 searches for the document corresponding to the search condition specified in S1 among the document corresponding to the document ID included in the bibliographic information extracted by the bibliographic information extracting unit 24 and outputs the search result to the document management unit 28.

The document management unit 28 generates a list of documents searched by the information searching unit 27 as a registered document list and transfers the generated document list to the image processing apparatus 1 via the transmitter/receiver 41 in S5.

The operating unit in the image forming apparatus 1 displays the document list transferred by the document management server in S5 as shown in FIG. 8. FIG. 8 is a diagram illustrating a screen displaying the document list as the search result in this embodiment. For example, it is assumed that the information in FIG. 5 is stored in the database 33. In this case, since “1.05” for the document version and “quality improvement” as the keyword are input as the search condition in FIG. 8, two documents satisfying the condition are found.

After accepting selecting a document on the document list and outputting the document, the operating unit 21 transfers an instruction on printing the document to the document management server 12 in S6. In FIG. 8, a debrief report on quality improvement whose version is 1.06 is selected. The document management unit in the document server 12 generates a print image of the document selected in S6 under the output condition specified in S1 based on the instruction on printing transferred in S6 and transfers the generated image to the image forming apparatus 1 in S7. Subsequently, the print output unit in the image forming apparatus 1 prints out the transferred image.

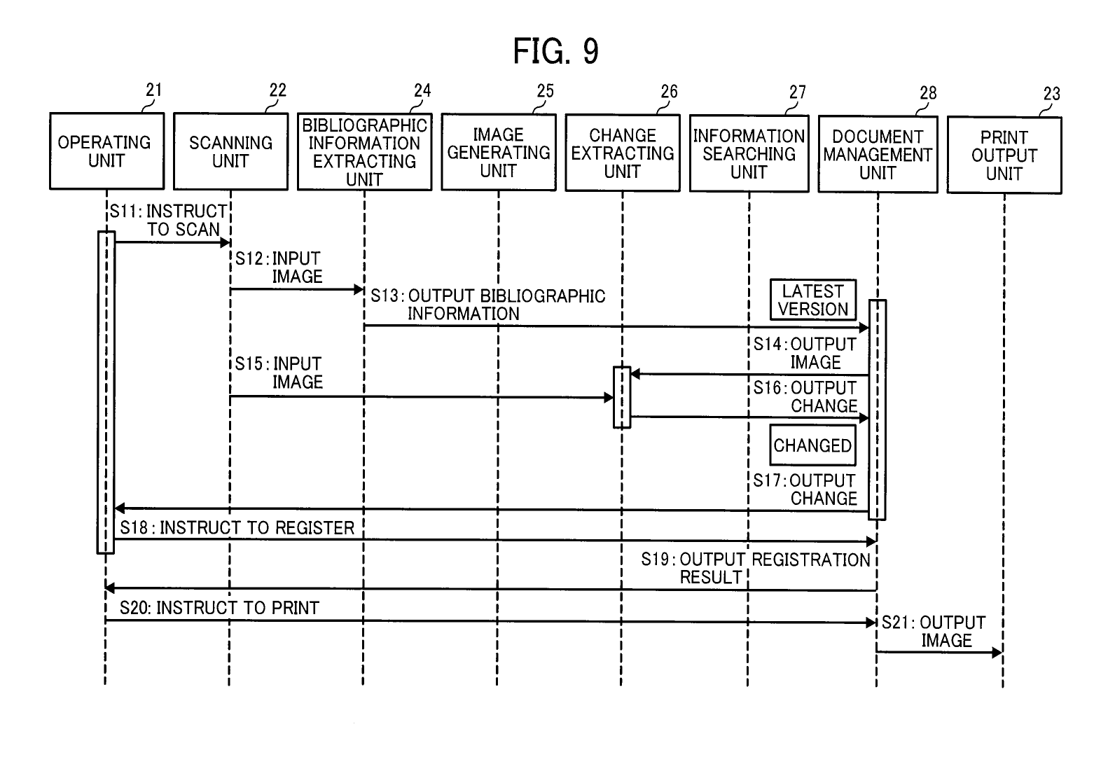

Next, a process that the latest version of the document 34 is specified is described below. In this case, it is assumed that the functions in FIG. 3 are implemented in the image forming apparatus 1, and only the database 33 is included in the document management server 12. FIG. 9 is a sequence diagram illustrating a process of updating and printing the registered document in this embodiment.

After the operating unit 21 in the image forming apparatus 1 accepts an instruction on scanning the cover sheet 35 by user operation, the scanning unit scans the document, and the image data of the document is generated in S11. In S12, the bibliographic information extracting unit 24 in the image processing apparatus 1 extracts the bibliographic information 36 included in the image data generated in S11.

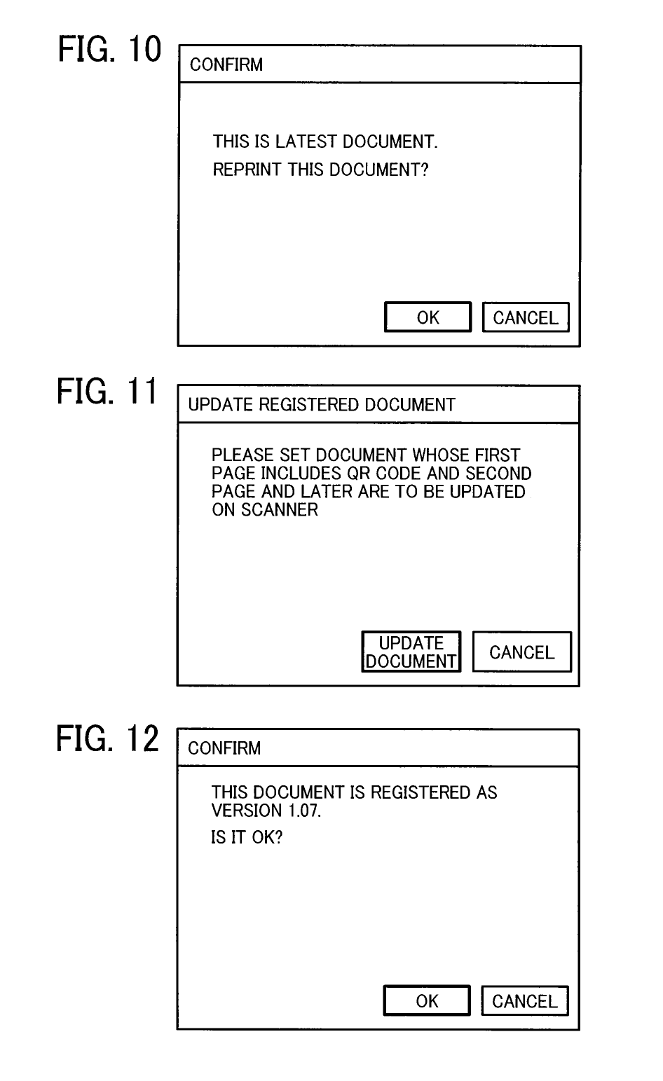

The document management unit 28 in the image processing apparatus 1 compares the document ID and the version included in the bibliographic information extracted by the bibliographic information extracting unit 24 with the document ID and the version stored in the database 33 and checks whether or not the version extracted by the bibliographic information extracting unit 24 is the latest in S13. FIG. 10 is a diagram illustrating a screen of checking whether or not it is the latest version in this embodiment. If the version of the document is the latest, the operating unit 21 displays a screen that inquires whether or not the document is reprinted.

If the operating unit 21 accepts a selection of reprinting, the latest version of the registered document is acquired from the database 33, the print image is generated based on the output condition accepted in S11, and the print output unit 23 prints out the generated print image in S21. By contrast, if the version of the document extracted by the bibliographic information extracting unit 24 is not the latest, the print image of the latest version of the registered document whose document ID is extracted by the bibliographic information extracting unit 24 based on the output condition accepted in S11, and the print output unit 23 prints out the generated print image.

Next, a process that updates the document using the cover sheet is described below. FIG. 11 is a diagram illustrating a screen of updating the registered document in this embodiment.

Before instructing to scan in S11 in FIG. 9, the image forming apparatus 1 displays a screen shown in FIG. 11. Subsequently, the image forming apparatus 1 accepts the instruction on scanning the document by recognizing that an “update document” button is pressed by user operation in S11.

After the scanning unit 22 in the image processing apparatus 1 scans the cover sheet 35 among the document set on the scanner 15 in S12, the bibliographic information extracting unit 24 in the image processing apparatus 1 identifies and extracts the bibliographic information printed on the cover sheet 35 in S13. Subsequently, based on the document ID included in the bibliographic information extracted in S13, the information searching unit 27 searches through the document information that the document management unit 28 manages and acquires a document image whose version is the latest from the database 33 in S14.

The scanning unit 22 in the image processing apparatus 1 scans the document other than the cover sheet among the document set on the scanner 15 and generates the scanned images. The change extracting unit 26 in the image processing apparatus 1 compares the generated images with the images acquired in S14. If there are some changes between the documents, a screen of checking whether or not the document is stored in the database 33 as a new version shown in FIG. 12 on the operating unit 21.

As shown in FIG. 12, the document management unit 28 generates a new version number based on the document version extracted by the bibliographic information extracting unit 24, and the operating unit 21 displays a message indicating that the document is registered with the new version in S17.

The image processing apparatus 1 registers the scanned images as the latest version in S18. After creating the cover sheet using the imaged bibliographic information and combining the cover sheet with the images scanned in S15, the document is registered in the document management unit 28.

Next, in S19, a message that the scanned images are registered is output. After the operating unit 21 accepts an input of instructing to print by user operation in S20, the print output unit 23 in the image processing apparatus 1 prints out the registered document that the document management unit 28 registers in S21.

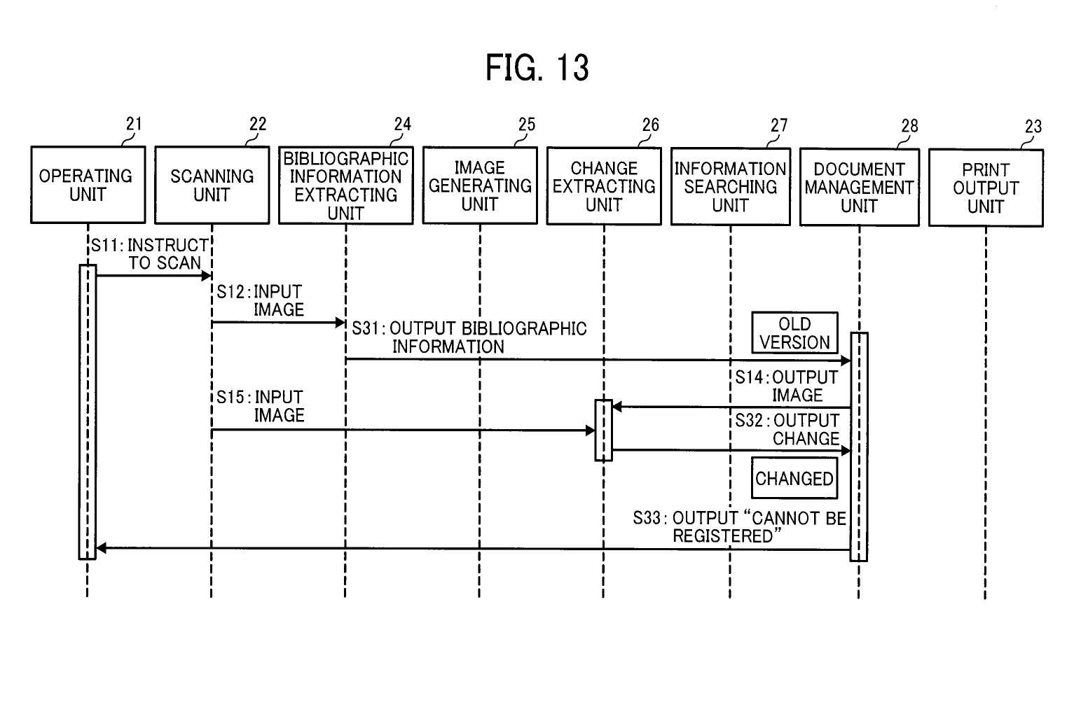

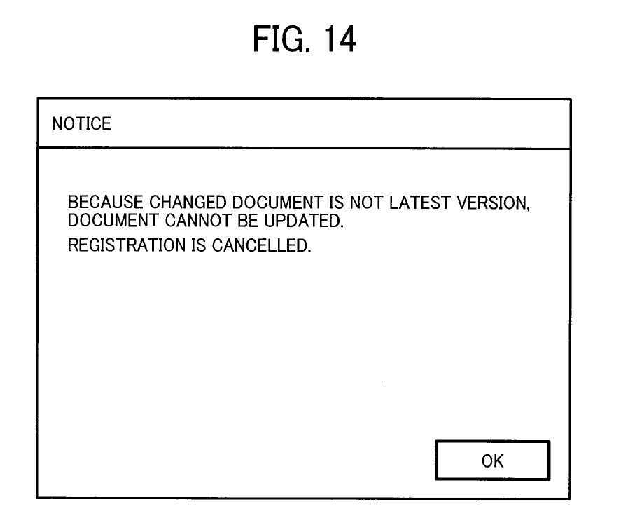

Next, a process if the bibliographic information included in the cover sheet 35 of the document 34 to be updated is already registered in the document management is described below with reference to FIG. 13. Before instructing to scan in S11 in FIG. 13, the image forming apparatus 1 displays the screen shown in FIG. 11. Subsequently, the image forming apparatus 1 accepts the instruction on scanning the document by recognizing that an “update document” button is pressed by user operation in S11.

After the scanning unit 22 in the image processing apparatus 1 scans the cover sheet 35 among the document set on the scanner 15 in S12, the bibliographic information extracting unit 24 in the image processing apparatus 1 identifies and extracts the bibliographic information printed on the cover sheet 35. Subsequently, based on the document ID included in the extracted bibliographic information, the information searching unit 27 searches through the document information that the document management unit 28 manages and compares the version information included in the extracted bibliographic information with the latest version information among the searched document information in S14.

After the comparison, if the version information included in the extracted bibliographic information is older than the latest version information among the searched document information, the screen shown in FIG. 12 is displayed on the operating unit 21 in S33. It should be noted that the document management unit 28 does not update the document information even if there is a change between the scanned images by the scanning unit 22 and the images stored in the database 33 in S32.

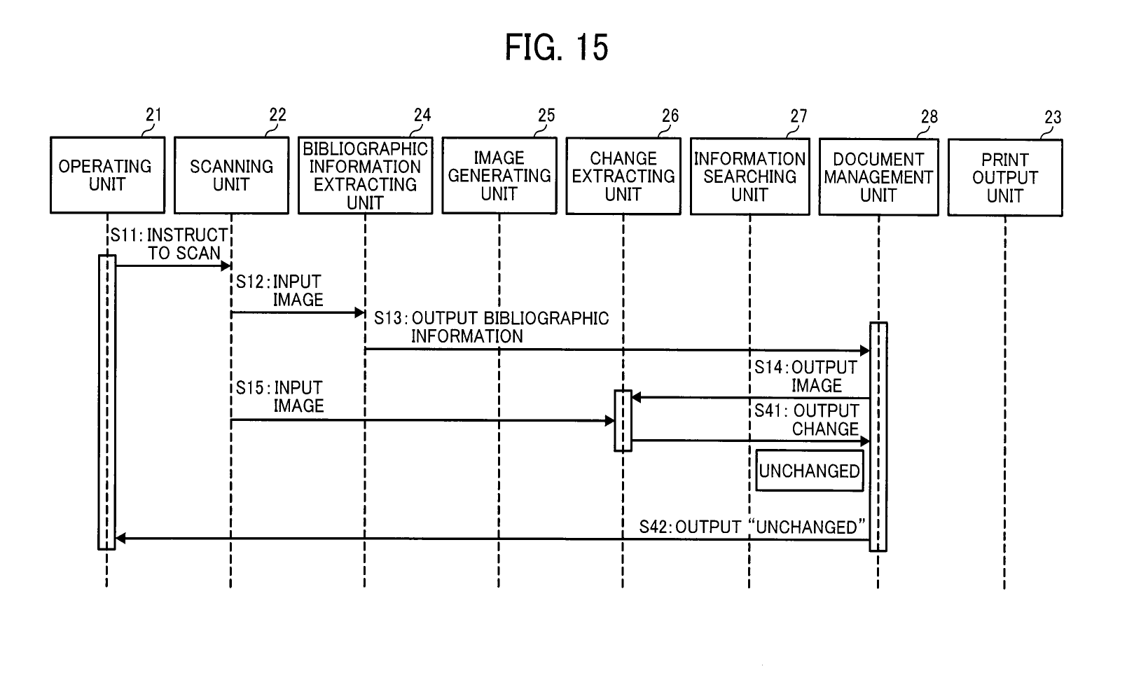

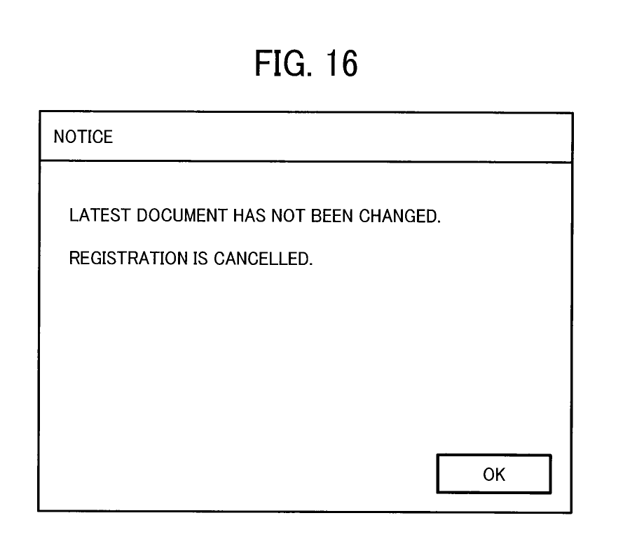

FIG. 15 is a sequence diagram illustrating a process if the extracted document remains unchanged in this embodiment. FIG. 16 is a diagram illustrating a screen that notifies that the document is not be registered in this embodiment. In FIG. 15, same symbols are assigned to the same steps as shown in FIG. 9, and the descriptions for those steps are omitted.

As shown in FIG. 15, if there is no change after comparing the scanned image in S4 with the images stored in the database 33 in S41, the message indicating that the document has not been changed and the document is not registered is displayed on the operating unit 21 in S42.

Numerous additional modifications and variations are possible in light of the above teachings. It is therefore to be understood that, within the scope of the appended claims, the disclosure of this patent specification may be practiced otherwise than as specifically described herein.

For example, either the image processing apparatus 1 or the document management server 12 can include functions shown in FIG. 4 except the print output unit 23, the transmitter/receiver 40, and the transmitter/receiver 41.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits. A processing circuit includes a programmed processor. A processing circuit also includes devices such as an application specific integrated circuit (ASIC) and conventional circuit components arranged to perform the recited functions.

What is claimed is:

1. A document management system, comprising:
an image processing apparatus including:
a scanning unit to scan a document into scanned image data; and
a transmission unit to transfer the scanned image data to an information processing apparatus as first image data; and
the information processing apparatus including:
a storing unit to store image data in association with update information that indicates a version of the image data;
an acquisition unit to acquire identification information for identifying the first image data transferred by the image processing apparatus;
a specification unit to obtain second image data corresponding to the identification information of the first image data, from among the image data stored in the storing unit;
a detection unit to compare the first image data with the second image data to detect difference between the first image data and the second image data; and
a registration unit to update update information of the second image data and register the first image data in association with the updated update information in the storing unit if the detection unit detects the difference.

2. The document management system according to claim 1, wherein the image processing apparatus further includes an output unit to output the first image data stored in the storing unit and the update information of the first image data, in response to an instruction to output the first image data that is received from the information processing apparatus.

3. The document management system according to claim 1, wherein
the acquisition unit further acquires update information indicating a version of the first image data from the first image data transferred by the image processing apparatus,
the detection unit compares the update information associated with the second image data with the update information of the first image data, and
the registration unit does not register the first image data transferred by the image processing apparatus if the update information of the first image data is older than the update information associated with the second image data.

4. The document management system according to claim 2, wherein the output unit of the image processing apparatus instructs a projector connected to the image processing apparatus to project an image based on the first image data.

5. A method of managing a document, comprising the steps of
storing image data in a memory in association with update information that indicates a version of the image data;
acquiring identification information for identifying first image data, the first image data being obtained by scanning a document;
obtaining second image data corresponding to the identification information of the first image data, from among the stored image data;
comparing the first image data with the second image data to detect difference between the first image data and the second image data;
updating update information of the second image data; and
registering the first image data in association with the updated update information in the memory if the difference is detected.

6. A non-transitory, computer-readable recording medium storing a program that, when executed by a processor, causes the processor to implement a method of managing a document, the method comprising the steps of:
storing image data in a memory in association with update information that indicates a version of the image data;
acquiring identification information for identifying first image data, the first image data being obtained by scanning a document;
obtaining second image data corresponding to the identification information of the first image data, from among the stored image data;
comparing the first image data with the second image data to detect difference between the first image data and the second image data;
updating update information of the second image data; and
registering the first image data in association with the updated update information in the memory if the difference is detected.
